(19) United States
(12) Patent Application Publication
(10) Pub. No.: US 2015/0039929 A1
(43) Pub. Date: Feb. 5, 2015

(54) Method and Apparatus for Forming Software Fault Containment Units (SWFCUS) in a Distributed Real-Time System

(71) Applicant: FTS Computertechnik GmbH, Wien (AT)

(72) Inventor: Stefan Poledna, Klosterneuburg (AT)

(73) Assignee: FTS Computertechnik GmbH

(21) Appl. No.: 14/379,728

(22) PCT Filed: Mar. 19, 2013
(86) PCT No.: PCT/AT2013/050068

§ 371 Date: Aug. 19, 2014

(30) Foreign Application Priority Data
Mar. 20, 2012 (AT) A 342/2012

(51) Int. Cl. G06F 11/07

(52) U.S. Cl. CPC G06F 11/0793; G06F 11/0709
USPC 714/2

(57) ABSTRACT

The invention relates to a method for limiting the effects of software errors in a distributed real-time system in which a plurality of distributed application systems are executed simultaneously, wherein each application system forms an encapsulated software fault containment unit (SWFCU), wherein an SWFCU comprises the software of a distributed application system, said software being executed on one or more virtual computer nodes and one or more dedicated computer nodes, and exchanging messages via one or more encapsulated virtual communication systems, wherein a communication system consists of communication controllers, switching units and physical connections, and wherein the direct effects of a software error of an SWFCU remain limited to the SWFCU.

The invention relates to a method for limiting the effects of software errors in a distributed real-time system in which a plurality of distributed application systems are executed simultaneously.

The invention also relates to a communication controller for a physical computer node for carrying out such a method.

The invention additionally relates to a communication controller for a personal computer for carrying out such a method.

The present invention lies in the field of computer engineering. It describes an innovative method and the assisting hardware, as can be formed in a distributed real-time computer system software fault containment unit (SWFCU), in order to limit the consequences of any occurring software errors to clearly delimited areas.

In many real-time applications, tasks of different criticality have to be performed. In a federated computer architecture, each of these tasks is performed on a distributed hardware system with dedicated computer nodes and a dedicated communication system in order to prevent errors of a system of a lower criticality class from being able to influence a system of a higher criticality class. This solution approach leads to a large number of computers, a high cabling outlay for the communication, and therefore to high costs.

The increasing rise in efficiency of the computer hardware caused by the higher integration density makes it possible, from a performance viewpoint, to integrate many application systems of different criticality on a single efficient distributed computer system. However, this is only feasible when the application software of a distributed application system can be encapsulated by the system architecture and the certified system software such that it is ensured that any software errors in an application system are unable to influence the functionality of another application system, either in terms of time or value.

The object of the invention is to disclose a new method for providing a spatial and temporal encapsulation of a distributed application system within a distributed computer system, such that a number of distributed application systems of different criticality can be integrated on a single distributed computer system.

This object is achieved with a method of the type mentioned in the introduction in that, in accordance with the invention, each application system forms an encapsulated software fault containment unit (SWFCU), wherein an SWFCU comprises the software of a distributed application system, said software being executed on one or more virtual computer nodes and one or more dedicated computer nodes, and exchanging messages via one or more encapsulated virtual communication systems, wherein a communication system consists of communication controllers, switching units and physical connections, and wherein the direct effects of a software error of an SWFCU remain limited to the SWFCU.

If a number of application systems are provided on a distributed computer architecture, it is thus expedient to distinguish between the following types of computer nodes: A physical computer node is a computer with CPU, memory and communication interface, for example a personal computer. A shared computer node is a physical computer node on which a number of application systems are provided, for example a personal computer on which a number of virtual machines are installed by means of a hypervisor or a corresponding partitioned operating system, for example as defined by the standard ARINC 653 [6]. The hypervisor encapsulates the virtual machines from one another spatially and temporally. A virtual computer node is one of the virtual machines of a shared computer node, inclusive of the associated communication controller, which encapsulates the messages of the virtual machines. A dedicated computer node is a physical computer node (inclusive of the communication controller), on which just a single application system is provided.

A physical communication system enables the message transport between the communication controllers of the physical computer nodes. A physical communication system consists of the communication controllers installed in the computers, the physical lines and the switching units. A number of partitions, that is to say virtual communication systems, can be arranged on a physical communication system by means of time control. A partition is active when it transmits messages. When a number of partitions are active within a given time interval, the physical communication system thus controls which messages are sent to which partitions over the physical lines at which moments in time.

A partition is encapsulated when the time guarantees with respect to the communication behaviour of a partition cannot be influenced by the behaviour of the other partitions active at the same time. Encapsulated partitions are present when the physical communication system is provided as a time-controlled communication system. Since the periodic time slots for transmission of the data and therefore the bandwidths are assigned a priori to the individual participants in a time-controlled communication system, a reciprocal temporal influencing of the partitions arranged on a physical communication system is excluded.

Messages are assigned in a predefined manner to what are known as virtual links, wherein virtual link <identifier>specifies the name of the virtual link. Virtual links have exactly one predefined transmitter and a predefined group of receivers. Messages can be transmitted either in a time-triggered or rate-constrained manner or in accordance with the best-effort principle. Time-triggered means that the messages are sent at predefined moments in time on the basis of a synchronised time basis. Rate-constrained means that a predefined minimum interval is observed between two messages of a virtual links. Best-effort means that the transmission of messages is not guaranteed [4].

In a partition, messages can be sent from one or more virtual links. In accordance with the type of communication of the messages, reference is made to time-triggered partition, rate-constrained partition, or best-effort partition. In addition, partitions that transmit messages in accordance with different principles are possible; such partitions are referred to as mixed partitions. Hereinafter, an identified communication channel in the communication system will be named as follows: virtual link <identifier>, wherein <identifier> specifies the name of the virtual link. A number of virtual links may be active simultaneously in a partition.

A physical communication system that is provided as a time-controlled communication system and in which one or more rate-constrained partitions and/or best-effort partitions and/or mixed partitions is/are active does not assign a time slot to each individual message of the rate-constrained/best-effort/mixed partition, but merely assigns a time slot for the sum of all messages of the corresponding partition. It is thus ensured that messages of different partitions cannot be influenced temporally.

In the field of computer reliability, the term fault containment unit (FCU) is of key significance [4, p. 136]. An FCU is understood to mean an encapsulated totality of sub-systems, wherein the direct effects of the cause of an error in one sub-system of the totality are limited to the specified totality. An application system forms such a totality, which may consist of the following sub-systems: (i) the software that runs on one or more virtual computer nodes, (ii) the software that runs on one or more dedicated computer nodes, and (iii) one or more encapsulated virtual communication systems which performs/perform the message transport between the virtual and dedicated computer nodes of the application system. Here, the term software fault containment unit (SWFCU) denotes an encapsulated totality of the software of a distributed application system which is executed on one or more virtual computer nodes and one or more dedicated computer nodes, and this term is used where the direct effects of a software error of this totality are encapsulated. The direct consequences of an error of an SWFCU are thus limited to this SWFCU and cannot influence another SWFCU provided in the distributed real-time system, either in terms of value or in terms of time. If each application system in an integrated distributed real-time system forms a dedicated distributed SWFCU, the reciprocal influencing of the application systems by software errors in the application systems can thus be excluded.

The present invention discloses an innovative method for forming software fault containment units (SWFCUs) distributed in a distributed real-time system. It is proposed for each of the application systems provided on a distributed real-time system to form its own SWFCU. It is thus ensured that a software error in an SWFCU cannot influence the correct function of the other SWFCUs.

Further advantageous embodiments of the method according to the invention are described in the dependent claims. By way of example, it is advantageous if a virtual computer node consists of a virtual machine (VM) managed on a computer by a hypervisor and of an encapsulated portion of a communication controller assigned exclusively to the VM.

It may also be advantageous if the communication controller converts the original data encapsulated spatially in the memory area into an assigned temporally encapsulated message and places the content of an incoming temporally encapsulated message in a spatially encapsulated memory area assigned to the message.

In addition, the virtual link identifier can be used to produce the assignment between temporally encapsulated messages and assigned encapsulated partitions of a communication controller.

It is expedient when, in a time-controlled communication system, a time slot is provided for the sum of all messages (time-triggered, rate constrained, best effort) of a mixed partition.

It is also advantageous if different SWFCUs communicate exclusively via messages.

Here, it is expedient if the switching unit assists a multicast communication, such that the messages exchanged between the SWFCUs can be monitored by an independent monitor component.

The above-mentioned object is also achieved with a communication controller for a physical computer node for carrying out an above-described method, wherein the communication controller converts the original data encapsulated spatially in the memory area of a virtual machine into an assigned temporally encapsulated message and stores the data arriving in a time-controlled message in an assigned spatially encapsulated memory area of a virtual machine.

The above-mentioned object is also achieved with a communication controller for a personal computer for carrying out an above-described method, wherein the communication controller observes the PCI interface standard and the data arriving in a time-controlled message is stored in an assigned spatially encapsulated memory area of a virtual machine.

The above-mentioned object is also achieved with a communication controller for a personal computer for carrying out an above-described method, wherein, alternatively or as a development of the above-described communication controller, the communication controller observes the TTEthernet standard.

The present invention will be explained on the basis of the following drawings of an example, in which

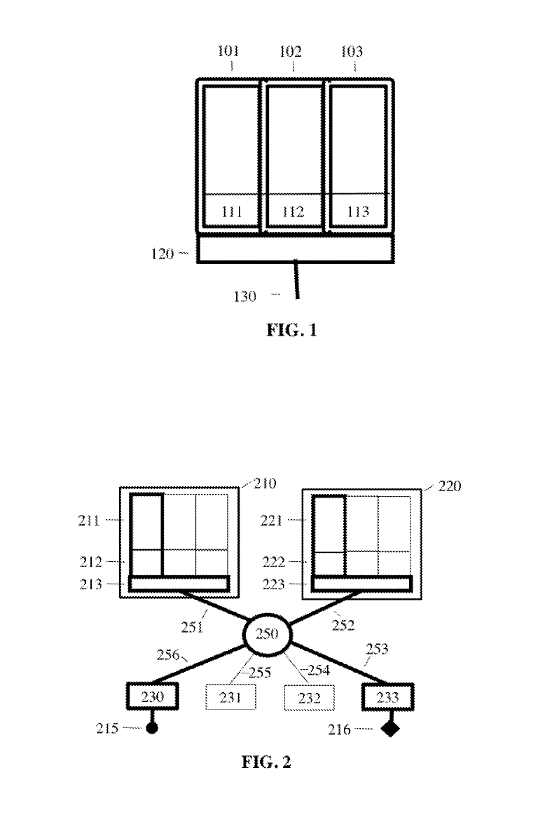

FIG. 1 shows a physical computer node on which three virtual computer nodes are provided, and

FIG. 2 shows an SWFCU consisting of two virtual computer nodes, a virtual communication system and two dedicated computer nodes.

The following specific example concerns one of the many possible implementations of the method according to the invention.

FIG. 1 illustrates a physical computer node on which three virtual machines 101, 102, 103 are provided. A dedicated memory area 111 of the virtual machine 101 can be addressed both by the virtual machine 101 and by the communication controller 120. This dedicated memory area 111 is the endpoint of a virtual communication channel provided on the physical communication channel 130. A number of temporally encapsulated virtual communication channels can be arranged on the physical communication channel 130 by means of time control. The communication controller 120 copies the spatially encapsulated data provided in the memory area 111 into a temporally assigned encapsulated message (and vice versa). The communication controller 120 provides the three encapsulated partitions 111, 112, 113, wherein each of the three virtual machines (VM) 101, 102, 103 managed by a hypervisor is assigned exclusively to a respective partition.

The memory areas 111, 112, 113, which are assigned to the virtual machines 101, 102, 103, form the endpoints of these virtual communication systems. Prior to the system start, the parameters of the virtual machines 101, 102, 103 and of the physical communication controller 120 are set by means of a certified system software (ZSW) in such a way that the software of a virtual machine does not receive any access rights to the memory areas of the other virtual machine, and time-controlled messages transported over the physical communication channel 130 are assigned to the corresponding memory areas 111, 112, 113 of the virtual machines 101, 102, 103. The methodology of the construction of virtual machines by hypervisor has already been disclosed in [1]. In the meantime, methods have been provided that make it possible to formally verify the correction of the software of a hypervisor [2]. The interface of the communication controller 120 to the CPU and/or memory of the physical computer node can be designed in accordance with the PCI standard [3]. The interface of the communication controller 120 to the time-controlled communication system 130 can be designed in accordance with the TTEthernet standard [5].

FIG. 2 shows a distributed real-time system consisting of two physical node computers 210, 220, a switching unit 250 and four dedicated node computers 230, 231, 232, 233. In this real-time system there are a number of software fault containment units (SWFCUs). The heavily outlined parts of FIG. 1 form one of these SWFCUs. This selected SWFCU comprises the virtual machine 211, the communication controller 213 and the interposed common memory 212, the communication channel 251 to the switching unit 250, the virtual machine 221, the communication controller 223 and the interposed common memory 222, the communication channel 252 to the switching unit 250, and the dedicated computer node 230 with the sensor 215 and the dedicated computer node 233 with the actuator 216, inclusive of the corresponding connections 256 and 253 to the switching unit 250. The two hypervisors in the physical computer nodes 210 and 220, the communication controllers 213 and 223 and also the communication protocol in the switching unit 250 prevent a software error outside this SWFCU from being able to influence the functioning of this SWFCU. The TTEthernet protocol [5] can be used in the switching unit 250 for encapsulation of the communication of this SWFCU. This protocol assists a deterministic time-controlled communication and also a rate-constrained communication and a best effort event-controlled communication. Alternatively, another protocol that encapsulates the communication channels temporally can also be used in the switching unit 250.

The communication between different SWFCUs provided on a distributed real-time system is to be performed via messages, wherein it is advantageous if these messages can be monitored by an independent monitor. This can be achieved when the switching unit 250 supports multicast communication.

### Cited Literature

[1] U.S. Pat. No. 4,949,254. Shorter. Method to manage concurrent execution of a distributed application program by a host computer and a large plurality of intelligent work stations on an SNA network. Granted Aug. 14, 1990

[2] Klein, G. et al. (2009). Formal Verification of an OS Kernel. Proc. Of the ACM SIGOPS 22nd Symposium on Operating System Principles. ACM Press.

[3] Peripheral Component Interconnect (PCI) Standard, Wikipedia. Accessed Mar. 3, 2012.

[4] Kopetz, H. Real-Time Systems, Design Principles for Distributed Embedded Applications. Springer publishing house. 2011.

[5] SAE Standard of TTEthernet. URL: http://standards.sae.org/as6802

[6] ARINC 653P1-3 Avionics Application Software Standard Interface, Part 1, Required Services: https://www.arinc.com/cf/store/catalog_detail.cfm?item_id=1487, 653P2-1 Avionics Application Software Standard Interface, Part 2—Extended Services: https://www.arinc.com/cf/store/catalog_detail.cfm?item_id=1072

1. A method for limiting the effects of software errors in a distributed real-time system in which a plurality of distributed application systems are executed simultaneously, characterised in that each application system forms an encapsulated software fault containment unit (SWFCU), wherein an SWFCU comprises the software of a distributed application system, said software being executed on one or more virtual computer nodes and one or more dedicated computer nodes, and exchanging messages via one or more encapsulated virtual communication systems, wherein a communication system consists of communication controllers, switching units and physical connections, and wherein the direct effects of a software error of an SWFCU remain limited to the SWFCU.

2. The method according to claim 1, characterised in that a virtual computer node consists of a virtual machine (VM) managed on a computer by a hypervisor and of an encapsulated partition of a communication controller assigned exclusively to the VM.

3. The method according to claim 1, characterised in that the communication controller (120) converts the original data encapsulated spatially in the memory area (111) into an assigned temporally encapsulated message and places the content of an incoming temporally encapsulated message in a spatially encapsulated memory area assigned to the message.

4. The method according to claim 1, characterised in that virtual link identifiers are used to produce the assignment between temporally encapsulated messages and assigned encapsulated partitions of a communication controller.

5. The method according to claim 1, characterised in that a time slot for the sum of all messages (time-triggered, rate constrained, best effort) of a mixed partition is provided in a time-controlled communication system.

6. The method according to claim 1, characterised in that different SWFCUs communicate exclusively via messages.

7. The method according to claim 6, characterised in that the switching unit (250) supports multicast communication, such that the messages exchanged between the SWFCUs can be monitored by an independent monitor component.

8. A communication controller for a physical computer node performing one or more of the method steps specified in claim 1, characterised in that the communication controller converts the original data encapsulated spatially in the memory area of a virtual machine into an assigned temporally encapsulated message and stores the data arriving in a time-controlled message into an assigned spatially encapsulated memory area of a virtual machine.

9. The communication controller for a personal computer performing one or more of the method steps specified in claim 1, characterised in that the communication controller observes the PCI interface standard and the data arriving in a time-controlled message is stored in an assigned spatially encapsulated memory area of a virtual machine.

10. A communication controller for a personal computer performing one or more of the method steps specified in claim 1, characterised in that the communication controller observes the TTEthernet standard.

11. A real-time system comprising a communication controller according to claim 8.
